(19) United States
(12) Patent Application Publication
(10) Pub. No.: US 2006/0067626 A1
(43) Pub. Date: Mar. 30, 2006

(54) Clamping member adapted to mount an optical connector pair in a connected state and capable of improving a component mounting density

(75) Inventors: Jun Takeda, Tokyo (JP); Yuichi Koreeda, Tokyo (JP)

Correspondence Address: WILLIAM COLLARD;COLLARD & ROE, P.C., 1077 NORTHERN BOULEVARD, ROSLYN, NY, 11576, US

(73) Assignee: Japan Aviation Electronics Industry, Limited

(21) Appl. No.: 11/237,551

(22) Filed: Sep. 28, 2005

(30) Foreign Application Priority Data
Sep. 28, 2004 (JP) 2004-281008

(51) Int. Cl. G02B 6/36

(52) U.S. Cl. 385/53

(57) ABSTRACT

In a clamping member for mounting an optical connector pair connected to each other in a first direction to an object, the clamping member includes a connector receiving portion for receiving the optical connector pair and a fixing portion to be fixed to the object. In addition, a coupling portion is provided to the clamping member for coupling the connector receiving portion and the fixing portion. The coupling portion separates the connector receiving portion from the object by a first dimension in a second direction perpendicular to the first direction.

This application claims priority to prior Japanese patent application JP 2004-281008, the disclosure of which is incorporated herein by reference.

### BACKGROUND OF THE INVENTION

This invention relates to a clamping member for holding an optical connector apparatus for splicing or connecting optical fibers to each other and to an equipment using the optical connector apparatus.

Recently, an optical connector apparatus is used in various equipments. Generally, the optical connector apparatus comprises an optical connector pair, i.e., a pair of optical connectors to be contacted with each other. For example, in case where the optical connector apparatus is mounted to an equipment, it is proposed to mount the optical connector pair in a connected state by the use of a clip member (for example, see Japanese patent (JP-B) No. 3286601).

The clip member comprises a plate-like coupling portion adapted to be directly fixed to a substrate and a pair of spring portions formed on opposite ends of the coupling portion to elastically clamp the optical connector pair in cooperation with each other. The coupling portion is provided with holes. By inserting screws into the holes, the clip member is fixed to the substrate.

By the use of the above-mentioned clip member, the optical connector pair is relatively easily attached and detached. Thus, the above-mentioned clip member is convenient. However, since the plate-like coupling portion is directly fixed to the substrate, it is necessary to secure, on the substrate, a large space corresponding not only to the size of the clip member but also to the size of the optical connector pair. Thus, the above-mentioned clip member is not advantageous in terms of improvement of a component mounting density on the substrate.

### SUMMARY OF THE INVENTION

It is therefore an object of this invention to provide a clamping member adapted to mount an optical connector pair in a connected state and capable of improving a component mounting density.

It is another object of this invention to provide an apparatus including the above-mentioned clamping member.

Other objects of the present invention will become clear as the description proceeds.

According to a first aspect of the present invention, there is provided a clamping member for mounting an optical connector pair connected to each other in a first direction to an object, the clamping member comprising a connector receiving portion for receiving the optical connector pair, a fixing portion to be fixed to the object, and a coupling portion for coupling the connector receiving portion and the fixing portion to separate the connector receiving portion from the object by a first dimension in a second direction perpendicular to the first direction.

According to a second aspect of the present invention, there is provide an equipment comprising the above-mentioned clamping member and an object to which the fixing portion is fixed.

According to a third aspect of the present invention, there is provide a clamping member for mounting an optical connector pair comprising a pair of connectors connected to each other in a first direction to an object, the clamping member comprising two holding portions for elastically holding the optical connector pair in the first direction, a main body coupling the holding portions to each other, two leg portions extending from the main body in a second direction perpendicular to the first direction and faced to each other in a third direction perpendicular to the first and the second directions, and two foot portions extending from the leg portions, respectively, to be fixed to the object.

### BRIEF DESCRIPTION OF THE DRAWINGS

FIG. 1 is a perspective view of a clamping member according to an embodiment of this invention;

FIG. 2 is a perspective view showing a state where an optical connector apparatus is mounted to an equipment by the use of the clamping member illustrated in FIG. 1;

FIG. 3 is an enlarged view of a characteristic part in FIG. 2;

FIG. 4 is an enlarged perspective view of the characteristic part in FIG. 2 as seen in a direction depicted by an arrow A;

FIG. 5 is a perspective view showing a state where a device is mounted below the clamping member illustrated in FIG. 4;

FIG. 6 is a perspective view showing a state where another optical connector apparatus is mounted below the clamping member illustrated in FIG. 4; and

FIG. 7 is a perspective view of another optical connector apparatus illustrated in FIG. 6 held by another clamping member.

### DESCRIPTION OF THE PREFERRED EMBODIMENTS

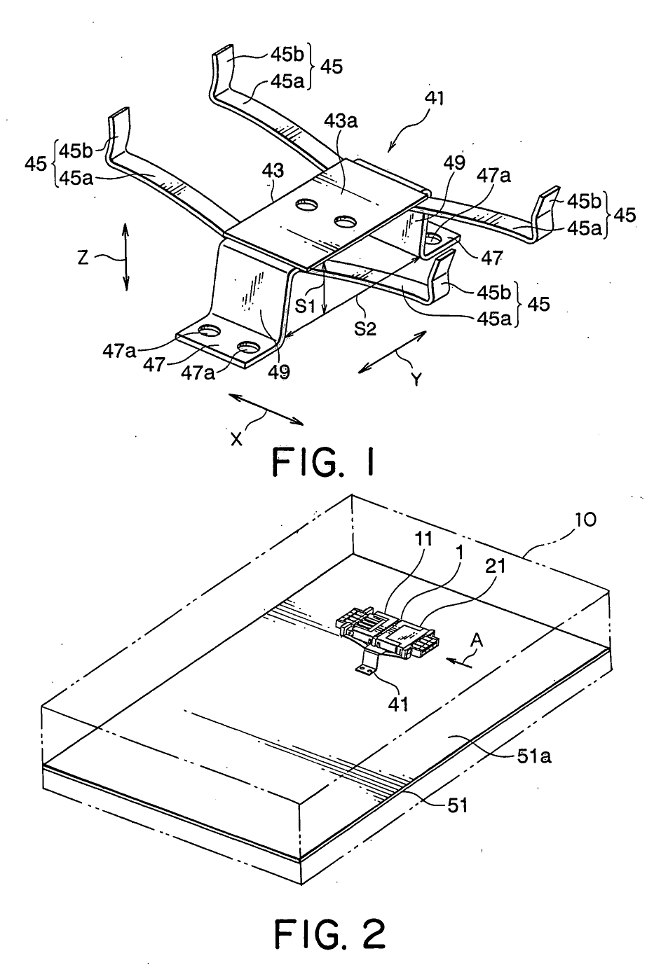

Referring to FIGS. 1 through 4, description will be made of a clamping member according to an embodiment of this invention.

The clamping member depicted at 41 in the figure is adapted to mount an optical connector apparatus 1 to an object such as a circuit board or substrate 51 of an equipment 10. The optical connector apparatus 1 comprises a first optical connector 11, a second optical connector 21, and an adapter 31 connecting the first and the second optical connectors 11 and 21 in a direction X (first direction) to each other. Herein, the first and the second optical connectors 11 and 21 will collectively be called an optical connector pair.

The first optical connector 11 has a first plug 15 holding a plurality of first optical fibers 13. The second optical connector 21 has a second plug 25 holding a plurality of second optical fibers 23 connected to the first optical fibers 13. The first and the second optical fibers 13 and 23 are inserted into the first and the second plugs 15 and 25, respectively. Inside the adapter 31, the first and the second optical fibers 13 and 23 are aligned in a direction Y (third direction) perpendicular to the direction X. By a centering member such as a sleeve (not shown) for aligning the centers of the first and the second optical fibers 13 and 23, the first and the second optical fibers 13 and 23 are aligned and brought into contact with each other on their end faces.

A connected state of the first and the second optical connectors 11 and 21 is maintained by a clamping member 41 for urging the first and the second plugs 15 and 25 towards each other. The clamping member 41 comprises a main body 43, a plurality of holding portions 45 coupled to the main body 43 to hold the first and the second optical connectors 11 and 21 in a connected state, a pair of foot portions 47 parallel to the main body 43, and a pair of leg portions 49 coupling the main body 43 and the foot portions 47 to each other.

The main body 43 has a plate-like shape in which a dimension in the direction Y is greater than that in the direction X. The dimension of the main body 43 in the direction Y is greater than that of each of the first and the second optical connectors 11 and 21.

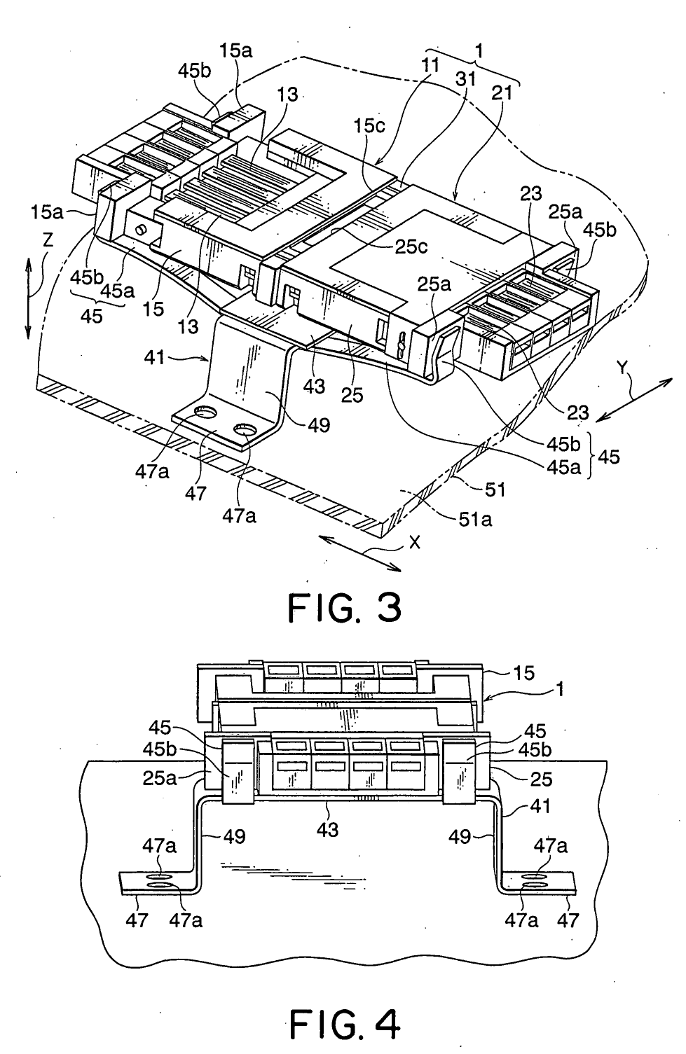

Each of the holding portions 45 has a beam part 45a with elasticity and a pair of pressing or engaging parts 45b formed at opposite ends of the beam part 45a. The beam part 45a extends roughly in the direction X and has a deformed portion at an intermediate portion thereof in the direction X. As clearly understood from FIGS. 1 and 3, the deformed portion is deformed downwardly with respect to the direction X.

In other words, each of the holding portions 45 has two ribbon plates extending roughly in the direction X from both sides of the main body 43, respectively, which are parallel to the direction Y Each of the ribbon plates extends from the both sides of the main body 43 in the direction X and is inclined upward from a top surface 43a of the main body 43.

Each engaging part 45b is substantially perpendicularly bent from each of the opposite ends of the beam part 45a. Therefore, the engaging parts 45b are faced to each other in the direction X with a space left therebetween. Each engaging part 45b is further bent from its intermediate position slightly outward.

As clearly shown in FIG. 3, the first and the second plugs 15 and 25 are press-fitted between the engaging parts 45b and held by the holding portions 45. At this time, the beam parts 45a serve as leaf springs for bringing the engaging parts 45b into elastic press contact with the first and the second plugs 15 and 25. Thus, the holding parts 45 serve as springs for urging the first and the second plugs 15 and 25 towards each other in the direction X with elastic force and restoring force. The holding portions 45 will collectively be called a clamping portion. A combination of the clamping portion and the main body 43 will be called a connector receiving portion.

The foot portions 47 are plate-like portions generally parallel to the main body 43. The foot portions 47 extend outward in the direction Y beyond opposite ends of the main body 43 in the direction Y The foot portions 47 serve to fix the clamping member 41 to the substrate 51. Therefore, the foot portions 47 will collectively be called a fixing portion.

The leg portions 49 extend in a direction Z (second direction) perpendicular to the directions X and Y Each of the leg portions 49 has a length selected so that a first dimension S1 from a mounting surface 51a of the substrate 51 to the main body 43 is greater than a dimension of each of the first and the second optical connectors 11 and 21 in the direction Z.

The leg portions 49 generally perpendicularly bent from the opposite ends of the main body 43 in the direction Y to face each other and extend in a direction opposite to the top surface 43a of the main body 43 to be integrally connected to the foot portions 47, respectively. A second dimension S2 between the leg portions 49 is greater than a dimension of each of the first and the second optical connectors 11 and 21 in the direction Y Herein, the leg portions 49 will collectively be called a coupling portion.

Next, description will be made of an operation of mounting the clamping member 41 to the board 51 and making the clamping member 41 hold the optical connector apparatus 1.

The clamping member 41 is fixed to the substrate 51 by inserting screws (not shown) through screw holes 47a formed on the foot portions 47 and tightening the screws. On the beam parts 45a of the holding portions 45, the optical connector apparatus 1 is placed. As a consequence, bottom surfaces of the first and the second optical connectors 11 and 21 of the optical connector apparatus 1 are faced to the beam parts 45a.

Further, the engaging parts 45b are brought into press contact with rear end faces 15a and 25a of the first and the second optical connectors 11 and 21 which are faced to the direction X. As a consequence, between the engaging parts 45b faced to each other, the first and the second optical connectors 11 and 21 are elastically pressed and held against each other so as to maintain contact between the first and the second plugs 15 and 25 and the adapter 31 on reference surfaces 15c and 25c. Therefore, in the first and the second optical connectors 11 and 21, end faces of the first and the second optical fibers 13 and 23 are brought into tight contact with each other by the use of reactive force of flexure of either the first or the second optical fibers 13 or 23.

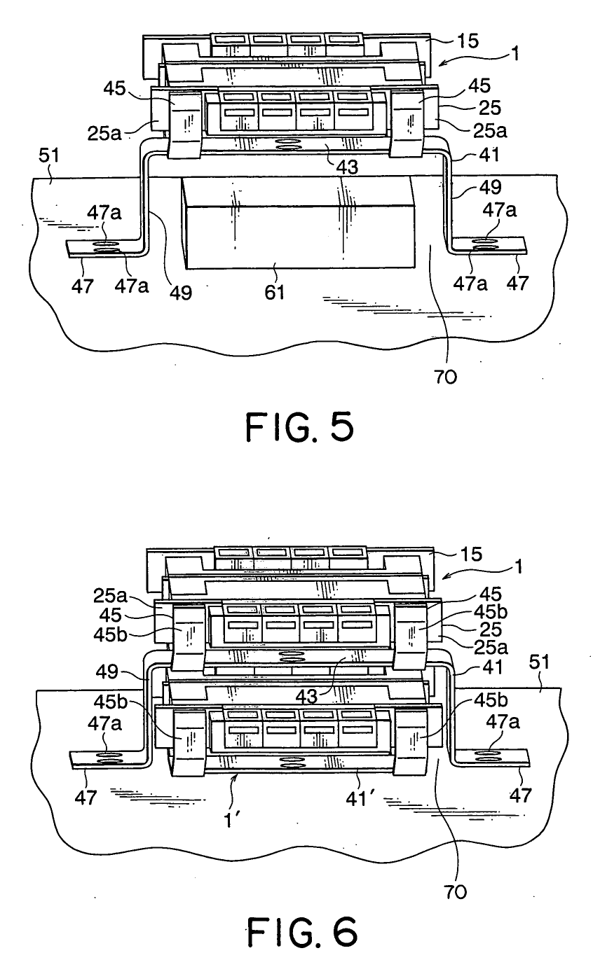

Referring to FIG. 5, a device 61 such as an electronic component mounted on the mounting surface 51a of the substrate 51 is disposed below the optical connector apparatus 1 illustrated in FIG. 4. In detail, a space 70 having the first dimension S1 in the direction Z and the second dimension S2 in the direction Y is formed inside the main body 43 and the leg portions 49 of the clamping member 41. Therefore, the device 61 can be disposed in the space 70 and mounted on the substrate 51.

Referring to FIG. 6, another optical connector apparatus 1′ is disposed in the space 70 below the optical connector apparatus 1. The optical connector apparatus 1′ is held by another clamping member 41′ and mounted on the mounting surface 51a of the substrate 51. The optical connector apparatus 1′ has an external dimension similar to that of the optical connector apparatus 1 described above. Similar parts are designated by like reference numerals and description thereof will be omitted.

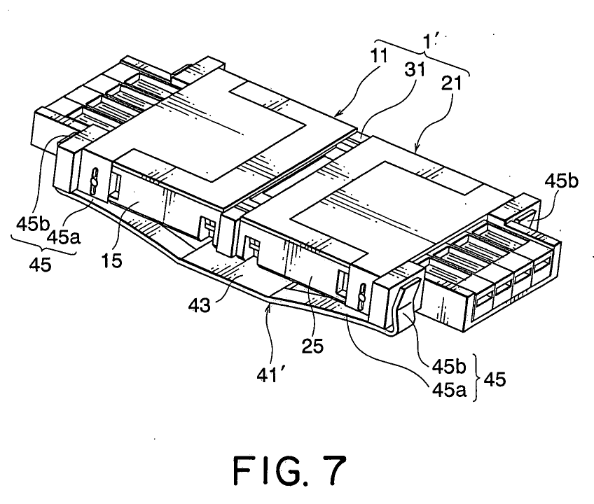

As clearly shown in FIG. 7, the clamping member 41′ is similar in shape and dimension to the connector receiving portion of the clamping member 41 described above. Specifically, the clamping member 41′ has a shape obtained by removing the foot portions 47 and the leg portions 49 from the clamping member 41. Thus, the optical connector apparatus 1 is held by the clamping member 41 and mounted above the mounting surface 51a of the substrate 51 while the optical connector apparatus 1′ is directly mounted to the substrate 51 below the clamping member 41. Since the optical connector apparatuses are mounted in double layers, it is possible to improve a component mounting density. As will readily be understood, the space 70 has dimensions in the directions Y and Z which are greater than those of the optical connector apparatus 1 or 1′.

In the foregoing, the optical connector apparatus 1′ is held by the clamping member 41′ of a special shape. Alternatively, the space 70 is designed to have a greater dimension so that a clamping member similar in shape to the clamping member 41 is disposed in the space 70 to hold the optical connector apparatus 1′. In this manner, the optical connector apparatuses can be mounted in three or more layers so as to further improve the component mounting density.

While this invention has thus far been disclosed in conjunction with the preferred embodiment thereof, it will be readily possible for those skilled in the art to put this invention into practice in various other manners. Although the clamping member is fixed by the screws in the embodiment, use may be made of a structure for press-fitting the foot portions to the object or of a fixing structure using soldering. In the foregoing description, the clamping member has a pair of foot portions and a pair of leg portions. Alternatively, the foot portion and the leg portion may be connected to only one end of the main body in the third direction. In this event, the other end of the main body in the third direction may be supported by a supporting portion which is not fixed to the object.

What is claimed is:

1. A clamping member for mounting an optical connector pair connected to each other in a first direction to an object, the clamping member comprising:
a connector receiving portion for receiving the optical connector pair;
a fixing portion to be fixed to the object; and
a coupling portion for coupling the connector receiving portion and the fixing portion to separate the connector receiving portion from the object by a first dimension in a second direction perpendicular to the first direction.

2. The clamping member according to claim 1, wherein the connector receiving portion has a clamping portion for clamping the optical connector pair in the first direction.

3. The clamping member according to claim 2, wherein the clamping portion has a plurality of holding portions spaced from each other in a third direction perpendicular to the first and the second directions, each of the holding portions having a pair of engaging parts faced to each other in the first direction, the engaging parts being engaged with opposite ends of the optical connector pair in the first direction, respectively.

4. The clamping member according to claim 3, wherein the holding portions respectively have beam parts each of which couples the engaging parts to each other, the connector receiving portion having a main body coupling the beam parts to each other.

5. The clamping member according to claim 4, wherein each of the beam parts extends in a deformed state with respect to the first direction so as to bring the engaging parts into elastic press contact with the optical connector pair.

6. The clamping member according to claim 5, wherein the beam parts extend in parallel to each other.

7. The clamping member according to claim 4, wherein the beam parts separate the optical connector pair from the main body when the optical connector pair is received by the connector receiving portion.

8. The clamping member according to claim 1, wherein the fixing portion has a pair of foot portions spaced from each other in a third direction perpendicular to the first and the second directions, the coupling portion having a pair of leg portions connecting the foot portions to the connector receiving portion and spaced from each other by a second dimension in the third direction.

9. The clamping member according to claim 8, wherein the second dimension is greater than a dimension of the optical connector pair in the third direction.

10. The clamping member according to claim 1, wherein the first dimension is greater than a dimension of the optical connector pair in the second direction.

11. An equipment comprising the clamping member according to claim 1 and an object to which the fixing portion is fixed.

12. The equipment according to claim 11, wherein the object is a substrate mounted to the equipment.

13. The equipment according to claim 11, further comprising another clamping member disposed between the object and the connector receiving portion to clamp another optical connector pair.

14. A clamping member for mounting an optical connector pair comprising a pair of connectors connected to each other in a first direction to an object, the clamping member comprising:
two holding portions for elastically holding the optical connector pair in the first direction;
a main body coupling the holding portions to each other;
two leg portions extending from the main body in a second direction perpendicular to the first direction and faced to each other in a third direction perpendicular to the first and the second directions; and
two foot portions extending from the leg portions, respectively, to be fixed to the object.

15. The clamping member according to claim 14, wherein each of the holding portions has a pair of engaging parts extending in the second direction in a direction substantially opposite to the coupling portion to be engaged with opposite ends of the optical connector pair in the first direction, respectively.
